(19) United States
(12) Patent Application Publication
(10) Pub. No.: US 2010/0297384 A1
(43) Pub. Date: Nov. 25, 2010

(54) TOKEN HAVING A DETECTION UNIT

(76) Inventors: Gerard Charlier, Paris (FR); Pierre Chapet, Beaune (FR)

Correspondence Address: Hershkovitz & Associates, LLC, 2845 Duke Street, Alexandria, VA, 22314, US

(21) Appl. No.: 12/305,353

(22) PCT Filed: Jul. 7, 2008
(86) PCT No.: PCT/IB08/54048

§ 371 Date: Mar. 12, 2009

(51) Int. Cl. B32B 1/06; B29C 45/14

(52) U.S. Cl. 428/76; 425/116; 264/275

(57) ABSTRACT

The invention relates to a flat token, comprising a detection unit which is enclosed between two half-shells (1, 15) which are produced from rigid plastics material, the two half-shells (1, 15) being coated with a synthetic resin, the token being distinguished in that at least one of the two half-shells (1, 15) comprise(s) means (21) for centering in a mould for injecting the resin.

The invention relates to a token or a similar flat device comprising a detection unit.

The term “detection unit” is intended to refer to any element which allows the token to be detected, such as, for example, an electronic unit which comprises an electronic chip which is associated with a transmitter/receiver system, or any other detection element of the alarm sheet or pad type which allows an audible alarm or the like to be actuated when it passes through a magnetic field. This last type of detection unit is found in particular on some consumer items, in particular in order to prevent the theft thereof.

The invention is used, inter alia, for the “contact-free” identification of persons and objects and for the identification of game tokens, in particular casino tokens.

The term “game token” is intended to refer to any token which can be used in a games hall and which represents a nominal value which may or may not be predetermined.

In practice, the detection unit is integrated in the body of the token produced from plastics material which is rigid and robust, thus forming a protective shell for the detection unit.

The electronic detection unit, comprising a chip which is associated with a transmitter/receiver system, may have different forms.

It may be produced in a rigid form, the chip and the transmitter/receiver system being fitted to a printed circuit board, for example. Such an electronic unit is described, for example, in the patent application WO 2007/06893.

It may also be produced in a flexible form, the chip being connected to the transmitter/receiver system comprising a coil of copper wire and being fitted to a flexible support. The chip can also simply be connected to the coil of copper wire, as described, for example, in the patent application FR 2 760 331.

Although it takes up less space than a rigid electronic detection unit, this last embodiment has the disadvantage of being more fragile.

In order to overcome this disadvantage, the patent application FR 2 760 331 proposes enclosing the electronic unit between two half-discs (or half-sheils) which are produced from rigid plastics material and which are fixedly joined to each other.

The object of the invention is to produce tokens which incorporate an electronic unit and which are produced by a single injection of material or resin into a mould, such tokens being less costly than if they are produced with a plurality of successive injection operations.

Such tokens are tokens of the same type as those to which the patent application FR-2 730 392 relates, having a design which is obtained by means of pad printing.

The insertion of a rigid electronic unit is complex in this type of token since it is bulky, thick and difficult to centre axially and radially, which makes it difficult to obtain tokens whose surface must be uniform in order to produce the pattern by means of pad printing.

The Applicant has thus sought to insert a flexible electronic unit into a token of this type, and, in order to produce a token of this type, has encountered the dual problem of fragility of such electronic units and obtaining a token whose surface is totally uniform in order to produce the pattern by means of pad printing.

The invention allows these two problems to be overcome.

It relates to a token of synthetic resin comprising a detection unit which is enclosed between two half-shells which are produced from rigid plastics material, the two half-shells being coated with the synthetic resin, the token according to the invention being distinguished in that at least one of the two half-shells comprise(s) means for centering in a mould for injecting the resin.

In this manner, the fragile detection unit is protected during the production of the token and the distribution of the resin injected into the mould is carried out in a substantially uniform manner around the two half-shells, which leads to the production of a token whose surface has substantially no irregularities, so that the token is capable of receiving a design by means of pad printing.

It is also important to obtain a flat surface of the token in order to allow them to be stacked on the gaming tables so that they can be readily handled.

In accordance with embodiments of the invention which will be described below, the means for radial centering may comprise at least two arms which protrude from the edge of the half-shell.

Furthermore, at least one of the arms may have at least one through-hole and/or at least one of the arms may have means for securing in the mould.

In particular, the securing means may be arranged at the ends of the arms.

According to another feature in accordance with the invention, the token may further comprise means for axially retaining the half-shells in the mould.

In this manner, when the resin is injected into the mould, the two half-shells comprising the detection unit do not yield under the weight and/or the pressure of the resin and remain centred substantially at one side and the other of the joint plane formed by the connection of the two half-moulds.

According to an embodiment which will be described and illustrated below, the retention means may comprise protruding pins on the outer surface of the half-shells.

In particular, the retention means may also comprise protruding pins on the centering means.

The token according to the invention may also comprise the following features, taken separately or in combination:
the half-shells each comprise a hollow half-disc,
each of the two half-shells has at least one through-hole which is capable of allowing the resin to pass through.

The invention also relates to a mould for producing a token as defined above, by means of injecting resin between two half-moulds, comprising a recess for receiving the detection unit enclosed between the two half-shells, the mould being distinguished in that at least one of the two half-moulds comprises members for co-operating with the centering means.

Finally, the invention relates to a method for producing a token as defined above, which is distinguished in that it involves the following steps:
positioning the detection unit in one of the two half-shells;
enclosing the detection unit by the other half-shell being arranged on the half-shell comprising the unit, in order to obtain a detection core,
positioning the detection core in the recess of the mould as defined above, by positioning the centering means in the co-operation members,
closing the mould,
injecting resin into the mould,
removing the token thus obtained from the mould,
and machining a portion of the token.

In particular, the method according to the invention may involve an additional step for fixing the detection unit in the half-shell before enclosing the detection unit.

In this manner, the unit remains in place in the half-shell, which allows easier handling of the detection core, in particular in order to position it in the injection mould.

The invention will be understood more clearly from the embodiments which will be set out below, with reference to the appended Figures, in which:

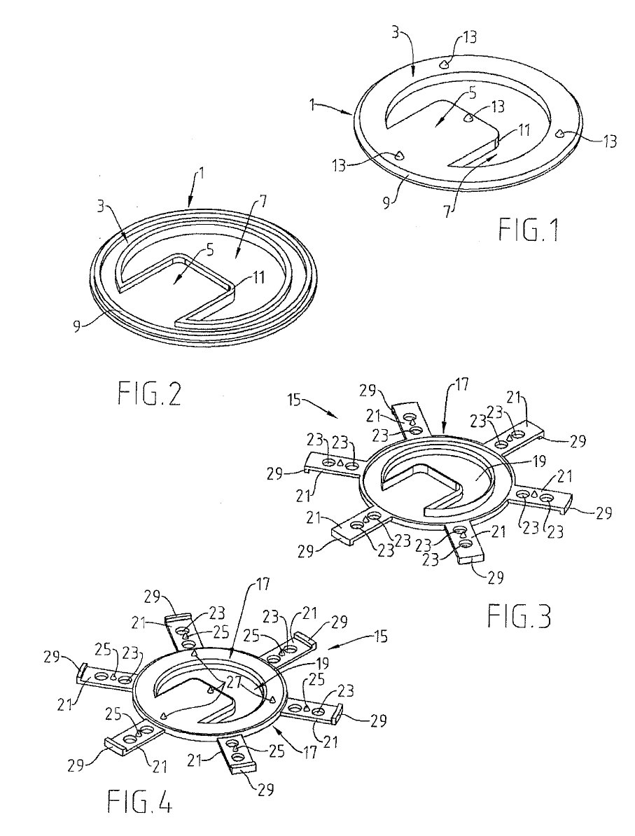

FIG. 1 is a perspective plan view of a first half-shell,

FIG. 2 is a perspective plan view of the first half-shell illustrated in FIG. 1, in an upturned position compared with that of FIG. 1,

FIG. 3 is a perspective plan view of a second half-shell,

FIG. 4 is a perspective plan view of the second half-shell illustrated in FIG. 3, in an upturned position compared with that of FIG. 1,

FIG. 5 is a perspective plan view of the first half-shell illustrated in FIG. 2, in which a detection unit has been arranged,

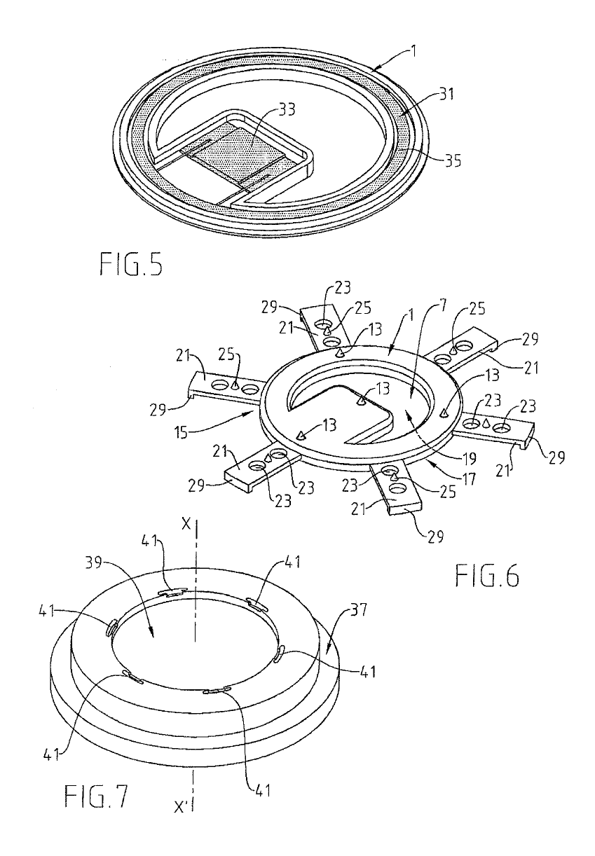

FIG. 6 is a perspective plan view of the two half-shells which are illustrated in FIGS. 1 and 3 and assembled,

FIG. 7 is a perspective plan view of a half-mould according to the invention,

FIG. 8 is a perspective plan view of the half-mould illustrated in FIG. 7, in which the two assembled half-shells of FIG. 6 are arranged,

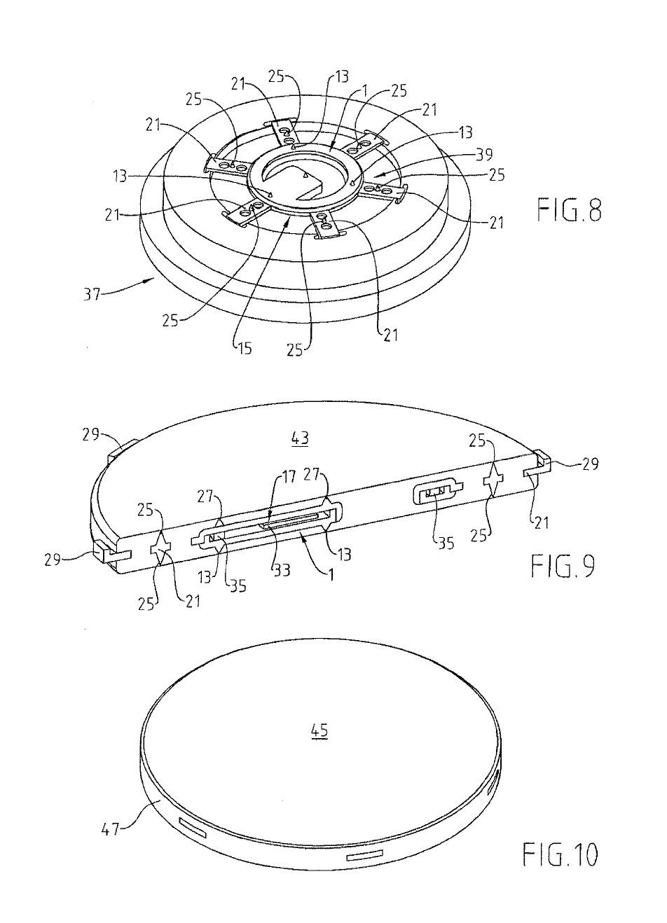

FIG. 9 is a perspective section through a token obtained after being removed from the mould, comprising the two assembled half-shells of FIG. 6 enclosing a detection unit,

FIG. 10 is a perspective view of the token of FIG. 9 after machining,

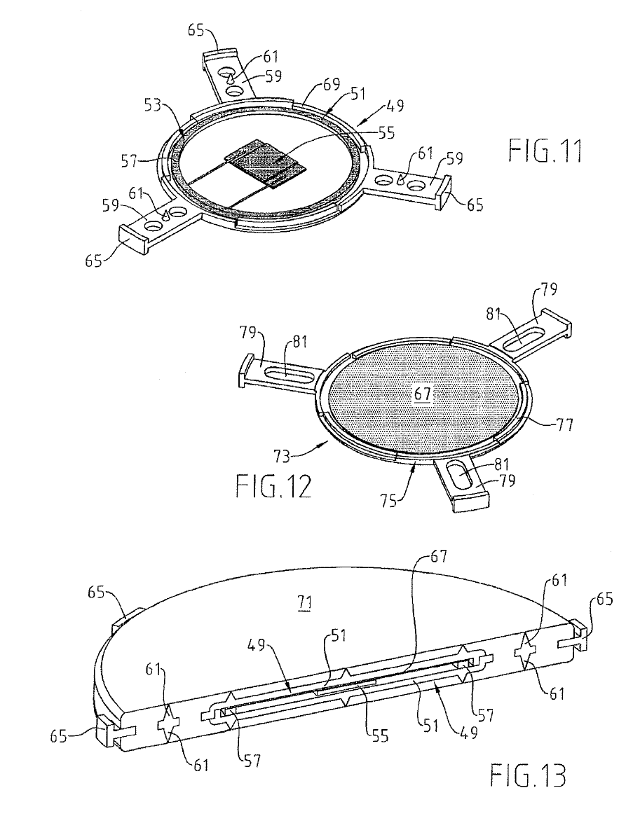

FIG. 11 is a perspective plan view of a half-shell according to a second embodiment, comprising a detection unit,

FIG. 12 is a perspective plan view of a half-shell according to a third embodiment, comprising a detection unit which is different from that illustrated in FIG. 11,

FIG. 13 is a perspective section through a token obtained after being removed from the mould, comprising two half-shells, one of which is that illustrated in FIG. 11 comprising the two detection units which are illustrated in FIGS. 11 and 12,

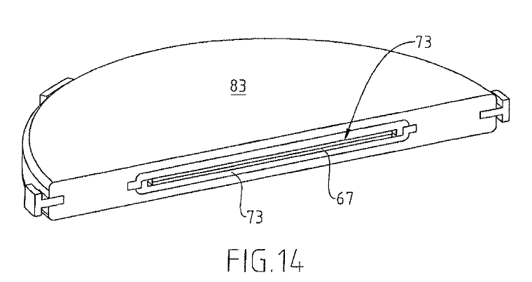

and FIG. 14 is a perspective section through a token obtained after being removed from the mould, comprising two half-shells, one of which is that illustrated in FIG. 12 comprising the detection unit illustrated in FIG. 12.

FIGS. 1 and 2 illustrate a first half-shell 1 which is intended to form a receptacle for a detection unit.

In order to simplify the understanding of the invention in the context of the following presentation of the embodiments, the half-shell which forms a receptacle for the detection unit will simply be referred to as a “receptacle”.

The receptacle 1 is produced by means of moulding hard plastics material, in a manner known per se to the person skilled in the art.

The receptacle 1 has a substantially annular portion 3 which is fixedly joined to a housing 5 extending from the annular portion towards the centre of the ring, the housing 5 being substantially rectangular or square.

This particular shape of the receptacle resembles that of a disc in which a through-hole (or opening) 7 has been provided.

In order to receive the reception unit, the receptacle 1 has an outer shoulder which protrudes from the surface of the annular portion, at the periphery thereof, and an inner shoulder 11 which protrudes from the inner periphery of the annular portion 3 and the housing 5.

On the opposite face of the receptacle to the one which is intended to receive the detection unit (face illustrated in FIG. 1), pins 13 protrude.

Three pins 13 are produced so as to be equidistant on the annular portion 3 and a pin 13 is provided on the face of the housing 5, near the centre of the receptacle 1.

The advantageous nature of the shape of the receptacle 1 and the pins 13 will be set out below.

FIGS. 3 and 4 illustrate a second half-shell 15, forming a cover for the receptacle 1.

In order to simplify the understanding of the invention in the context of the following presentation of the embodiments, the second half-shell forming a receptacle for the detection unit will be referred to simply as a “cover”.

The cover 15 is produced by means of moulding hard plastics material, in a manner known per se to the person skilled in the art.

The cover 15 has a central portion 17 whose shape complements that of the receptacle 1.

It thus has an annular portion which is fixedly joined to a substantially rectangular or square housing and which extends from the annular portion towards the centre.

The shape of the central portion 17 thus resembles a disc-like shape in which a through-hole 19 has been provided.

The shapes of the central portion 17 of the cover 15 and that of the receptacle 1 are thus complementary.

As can be seen in particular in FIG. 6, the receptacle 1 fits naturally below the cover 1, the openings 7 and 19 facing each other.

The openings 7 and 19 in particular allow resin to be introduced to the centre of the token during the moulding operation, so that it is difficult to retrieve the assembly comprising the cover 15/receptacle 1 by destroying the resin without destroying the casing or the receptacle.

The central portion 17 of the cover 15 has, protruding from the periphery thereof, six arms 21 which are distributed in a uniform manner around the centre of the cover.

The six arms constitute radial and axial centering means for the cover and the receptacle fitted (or assembled) in a resin injection mould.

In the context of this embodiment, each of the arms 21 has two through-holes 23 which allow the resin to pass through each of the arms 21. In this manner, the arms are enclosed in the resin when the token is moulded. It is impossible to retrieve the assembly comprising the cover 15/receptacle 1 and detection unit by destroying the resin without also destroying the cover 15 or the receptacle 1.

The advantage of such an embodiment is to dissuade malicious persons from reproducing the token since it cannot be dismantled without destroying the components which it comprises.

Each of the arms 21 is substantially flat, having two parallel faces.

A pin 25 protrudes at each of the faces of each of the arms.

Furthermore, four pins 27 protrude from the outer surface of the central portion 17 of the cover 15.

Of the four pins 27, three pins 27 are produced so as to be equidistant on the ring of the central portion 17, and one is arranged on the housing, near the centre of the cover.

Furthermore, each of the arms 21 comprises means for securing in a mould. These securing means are produced by shoulders 29 which are produced at the ends of the arms 21.

The shoulders 29 form hooks which allow the assembly comprising the cover 15/receptacle 1 surrounding the detection unit to be retained in position in the mould.

FIG. 5 illustrates a first detection unit 31 which is inserted into the receptacle 1.

The detection unit is an electronic unit 31 which comprises a chip 33 which is capable of storing data and which is connected to a transmitter/receiver system 35 which comprises an antenna which is in the form of a coil.

It should be noted that the shape of the receptacle 1 complements that of the electronic unit 31. On the one hand, this shape allows a through-hole to be provided in the cover 15/receptacle 1 assembly comprising the electronic unit 31, also referred to as the detection core, which allows resin to be introduced into the core of the token as set out above. On the other hand, this shape is advantageous from a financial point of view since the production of the cover 15 and the receptacle 1 requires less material.

In order to retain the electronic unit 31 in place in the receptacle 1, provision is made to fix the electronic unit in the receptacle, for example, by means of adhesive-bonding or any similar means.

FIG. 7 illustrates a half-mould 37 of a mould which is intended for the production of a token as described with reference to FIGS. 1 to 6.

The half-mould 37 comprises a cylindrical recess 39 having an axis X-X′ at the centre of which the detection core is arranged, as illustrated in particular in FIG. 8.

The half-mould 37 also comprises housings 41 which are arranged so as to be equidistant around the recess 39.

The housings 41 are capable of receiving the end of the arms 21. In this manner, the housings 41 constitute means for co-operation with the means 21, 29 for axial and radial centering of the detection unit in the mould.

The housings 41 are produced in the form of small cavities which are in the shape of grains of rice, and are open in the direction towards the recess 39.

The shoulders 29 of the ends of the arms 21 form hooks and allow each arm to be retained in position in each housing 41.

The recess 39 has the shape of the token.

In this instance, the token is a games token which is in the form of a flat disc.

The recess 39 is therefore in the form of a disc and the depth thereof substantially corresponds to half of the thickness of the token.

The pins 13, 25 and 27 produced respectively on the receptacle 1 and the cover 15 allow the central portion of the detection core to be retained substantially in the joint plane of the mould, that is to say, in the joint plane of the two half-moulds when they are positioned one on top of the other in order to produce the token or in an adjacent parallel plane.

In a more precise manner, the pins allow the central portion of the core to be retained in a centre plane of the two half-recesses of the mould so that the core is centred in a centre plane of the token.

When the resin is injected into the mould, the central portion of the detection core may tend to be pushed against an inner wall of the recess under the effect of the pressure and the heat in spite of the rigidity of the two assembled half-shells. If this should occur, the resin cannot be distributed in a uniform manner around the detection core which may cause problems with respect to the state of the surface of the token and prevent a design from being produced by means of pad printing.

The pins 13, 25 and 27, being supported against the opposing bases of the mould, allow a constant distance to be maintained between the detection core and the inner walls of the mould 37, which overcomes the problem set out above.

A single half-mould of the mould according to the invention has been illustrated in FIG. 7 or 8. The other half-mould may be a conventional half-mould, comprising only the recess of the token.

However, it must be understood that a mould comprising two half-moulds such as that described and illustrated in FIGS. 7 and 8 would also be a mould in accordance with the invention.

The production method of a token as described above is as follows.

The detection unit 31 is arranged in the receptacle 1, being adhesively-bonded if necessary. The cover 15 is fitted to the receptacle 1 and the detection core obtained in this manner is arranged in the half-mould 37 which is provided with the housings 41 in order to receive the securing means 29 at the ends of the arms 21. The mould is then closed and the detection core is centred therein both radially and axially by the arms 21, the centering further being ensured by the pins 25. Resin is injected into the mould using means (not illustrated) which are well known to the person skilled in the art. During this operation, the detection core is retained axially relative to the opposing bases of the mould, which allows the resin to completely cover the core and allows a token to be obtained which has planar faces which are suitable for pad printing, and radially, which promotes the correct operation of the detection unit, in particular if a reading unit has to detect tokens which are superimposed in a stack.

FIG. 9 illustrates a token 43 obtained, after being removed from the mould.

The token 43 has, protruding from the peripheral surface thereof, the arm ends 21 which have the shoulders 29 for securing in the half-mould 37.

Therefore, in accordance with the method according to the invention, a final machining step, for example, on a lathe, is required to eliminate these arm ends 21.

As illustrated in FIG. 10, after machining, the games token 45 obtained has a smooth portion 47 which is capable of receiving a design by means of pad printing.

Reference will now be made to another embodiment of a token according to the invention.

FIG. 11 illustrates, by way of example, a receptacle 49 which has a central portion 51 which is in the form of a solid disc, for receiving a detection unit 53 which is substantially identical to the detection unit 31 illustrated in FIG. 5, with the exception that the detection unit 53 which is also an electronic unit, comprises a chip 55 which is arranged substantially at the centre of a coil 57 which forms a transmitter/receiver system.

The receptacle 49 also comprises three arms 59 which are produced so as to be equidistant around the central portion 51.

Each of the arms 59 has a pin 61 which allows retention in a plane adjacent to and parallel with the joint plane of the mould, in particular during the operation for injecting resin into the mould.

Each of the arms 59 also has two through-holes 63 which allow resin to pass through each of them.

Finally, each of the arms 59 has, at the end thereof, means for securing in a half-mould. These securing means are produced by the arm 65 terminating with a T-shaped cross-section.

Such a termination 65 involves the use of a mould according to the invention, each of the half-moulds of which comprises not only the recess of the token to be produced, but also housings for each of the ends of the arms 59.

Furthermore, the advantage of such a central portion 51 produced by means of a solid disc is that it allows, in addition to the electronic unit 53, an additional detection unit to be received, such as a detection sheet 67 which is in the form of a pad.

The advantage of having two detection units is, on the one hand, to allow the tokens to be provided with simple detection means which are only capable of actuating an alarm when passing close to a magnetic field, for example, (detection sheet 67), and, on the other hand, to provide the tokens with improved detection units 53 which are capable of communicating via radio frequency with a unit which allows, for example, the position of a token to be identified and detected geographically.

The detection sheet 67 may simply be arranged on the electronic unit 53 in the central portion 51 of the receptacle 49.

A second receptacle 49 identical to that illustrated in FIG. 11 may also act as a cover.

To this end, the central portion 51 has an edge 69 which is produced in the form of notches which are offset circumferentially so that two central portions 51 of two receptacles 49 may fit one inside the other with the arms 59 being offset in a star-like configuration having six branches which are mutually offset by the same angle.

FIG. 13 illustrates the token 71 obtained from a detection core which comprises two receptacles 49 which are assembled and which enclose the detection sheet 67 and the electronic unit 53.

FIG. 12 illustrates a variant of the receptacle 73 which may also act as a cover.

The receptacle 73 has a central portion 75 which also has an edge 77 which is produced in the form of notches which are offset circumferentially and three arms 79 which are distributed so as to be equidistant around the central portion 75.

According to this embodiment, the arms 79 each comprise a single through-hole 81 but no pin.

The end of each arm is T-shaped.

The receptacle 73 receives only a detection sheet 67.

FIG. 14 illustrates a token 83 after being removed from the mould, obtained from a core which is formed by two receptacles 73 which are assembled and which enclose a detection sheet 67.

The invention could also be used for the following embodiment which has not been illustrated in the Figures.

The token could comprise, in addition to the detection unit enclosed between two half-shells, a second detection unit which comprises two filaments which are arranged in the form of a cross, and which allow, for example, an alarm to be actuated when passing close to a magnetic field, in a similar manner to the detection sheet 67.

In order to prevent occurrences of interference with the detection unit enclosed between the two half-shells, the two filaments are fixed to the outer side of the two half-shells.

Each half-shell has a filament which is fixed, for example, by means of adhesive-bonding along a diameter if the half-shell is round in shape.

Furthermore, the half-shells which each have a filament are fixedly joined to each other, so that the filaments intersect along perpendicular planes.

It will be appreciated from the above how the means described allow the detection core to be retained in a centred position in the mould during the injection of resin, in order to obtain a correct distribution of resin around the detection core and consequently a token whose surface is substantially planar for receiving a design by means of pad printing.

However, it must be appreciated that the invention is not limited to the embodiments which have been described above and that it extends to any equivalent embodiment.

For example, the token according to the invention could comprise a detection core comprising less than six arms, at the very least at least two arms in order to allow the core to be centred in the mould. These two arms could be produced so as to be diametrically opposed relative to the central portion of the core.

In the same manner, the arms or the tokens could even be produced so as to have a different shape.

1. A flat token of synthetic resin, comprising a detection unit (31; 53; 67) which is enclosed between two half-shells (1, 15; 49; 73) which are produced from rigid plastics material, the two half-shells (1, 15; 49; 73) being coated with the synthetic resin, wherein at least one of the two half-shells (1, 15; 49; 73) comprises means (21; 59; 79) for centering in a mould for injecting the resin.

2. A token according to claim 1, wherein the radial centering means (21; 59; 79) comprise at least two arms (21; 59; 79) which protrude from the edge of the half-shell (15; 49; 73).

3. A token according to claim 2, wherein at least one of the arms (21; 59; 79) has at least one through-hole.

4. A token according to claim 2, wherein at least one of the arms (21; 59; 79) has means (29, 65) for securing in the mould.

5. A token according to claim 4, wherein the securing means (29, 65) are arranged at the ends of the arms (21; 59; 79).

6. A token according to claim 1, further comprising means (13; 25; 61) for axially retaining the half-shells in the mould.

7. A token according to claim 6, wherein the retention means (13; 25; 61) comprise protruding pins (13) on the outer surface of the half-shells.

8. A token according to claim 6, wherein the retention means comprise protruding pins (25, 61) on the radial centering means (21; 59).

9. A token according to claim 1, wherein the half-shells (1, 15; 49; 73) each comprise a hollow half-disc.

10. A token according to claim 1, wherein each of the half-shells (1, 15) has at least one through-hole (7, 19) which is capable of allowing the resin to pass through.

11. A mould for producing a token according to claim 1, by means of injecting resin between two half-moulds, comprising a recess (39) for receiving the detection unit (31; 53; 67) enclosed between the two half-shells (1, 15; 49; 73), wherein at least one of the two half-moulds (37) comprise(s) members (41) for co-operating with the radial centering means (21; 59; 79).

12. A mould according to claim 11, wherein the co-operation members comprise housings (41) for receiving retention means (29, 65) provided at the end of the arms.

13. A method for producing a token according to claim 1, including the steps of:
positioning the detection unit (31; 53; 67) in one of the two half-shells (1, 15; 49; 73);
enclosing the detection unit (31; 53; 67) by the other half-shell (1, 15; 49; 73) being arranged on the half-shell (1, 15; 49; 73) comprising the unit (31; 53; 67), in order to obtain a detection core,
positioning the detection core in the recess of a mould as defined by claim 11, by positioning the centering means (21; 59; 79) in the co-operation members (41),
closing the mould,
injecting resin into the mould,
removing the token (43; 71; 83) thus obtained from the mould,
and machining a portion of the token (43; 71; 83).

14. A production method according to claim 15, including the step of fixing the detection unit (31; 53; 67) in the half-shell (1, 15; 49; 73) before enclosing the detection unit (31; 53; 67).

15. A mould for producing a token according to claim 2, by means of injecting resin between two half-moulds, comprising a recess (39) for receiving the detection unit (31; 53; 67) enclosed between the two half-shells (1, 15; 49; 73), wherein at least one of the two half-moulds (37) comprise(s) members (41) for co-operating with the radial centering means (21; 59; 79).

16. A mould according to claim 15, wherein the co-operation members comprise housings (41) for receiving retention means (29, 65) provided at the end of the arms.
